(19) United States
(12) Patent Application Publication
(10) Pub. No.: US 2012/0002253 A1
(43) Pub. Date: Jan. 5, 2012

(54) IMAGE FORMING APPARATUS AND LIGHT AMOUNT ADJUSTING METHOD

(75) Inventors: Katsuya Nagamochi, Tokyo (JP); Mitsuru Hatano, Kanagawa-ken (JP); Sueo Ueno, Shizuoka-ken (JP); Hiroyuki Shiraishi, Shizuoka-ken (JP); Yusuke Hashizume, Chiba-ken (JP); Koji Shimokawa, Shizuoka-ken (JP); Naoya Koseki, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/175,066

(22) Filed: Jul. 1, 2011

Related U.S. Application Data
(60) Provisional application No. 61/361,350, filed on Jul. 2, 2010.
(60) Provisional application No. 61/361,351, filed on Jul. 2, 2010.
(60) Provisional application No. 61/361,354, filed on Jul. 2, 2010.

(51) Int. Cl. H04N 1/46

(52) U.S. Cl. 358/509

(57) ABSTRACT

According to one embodiment, an image forming apparatus includes: a light source unit including light emitting elements for red, green, and blue; an image pickup section configured to receive, from a reference board on which light from the light source unit is irradiated, reflected light to pick up an image of the reference board; and a control section configured to control the light emitting elements of the light source unit to separately emit light, acquire separate data picked up by the image pickup section, select data having a smallest luminance value among the separate data, and control light amounts of all the light emitting elements of the light source unit with the selected data set as a reference.

### CROSS-REFERENCE TO RELATED APPLICATIONS

This application is based upon and claims the benefit of priority from: U.S. provisional application 61/361,350, filed on Jul. 2, 2010; U.S. provisional application 61/361,351, filed on Jul. 2, 2010; U.S. provisional application 61/361,354, filed on Jul. 2, 2010; the entire contents all of which are incorporated herein by reference.

### FIELD

Embodiments described herein relate generally to a technique for controlling a light source configured to emit light when an image forming apparatus reads an image.

### BACKGROUND

In the past, as a light source for image reading used in an image forming apparatus, a halogen lamp and a xenon lamp are mainly used. However, recently, an LED array in which plural LED elements are arrayed is adopted as a light source according to efforts at a reduction in power consumption and an increase in luminance.

If LED elements for plural colors of R (red), G (green), and B (blue) are adopted as light sources or if plural sets of LED elements for R, G, and B are used, fluctuation in a light amount due to individual differences occurs. Therefore, light amount adjustment for the LED elements is necessary.

In order to perform the light amount adjustment, in the past, for the purpose of a reduction in an adjustment time, one LED element determined in advance among the plural LED elements is caused to emit light under a rated condition and light amount adjustment for the other LED elements is performed with a light amount of the LED element set as a reference. In this case, a light amount of light emission of all the LED elements could exceed a saturation level, which is a limit of luminance identification for an image pickup element such as a CCD sensor (Charge Coupled Device Image Sensor). Therefore, even if the light amount adjustment for the respective LED elements can be performed, when an original document is actually read or when the image forming apparatus performs adjustment of an analog front end offset for performing digital conversion or gain adjustment, in some case, an error occurs and the image pickup element does not normally operate.

On the other hand, in the related art of the LED array, even if a supply current to the LED array is constant, because of characteristics of the LED elements, a light amount of document irradiation fluctuates if environment temperature changes. Therefore, unevenness occurs in illuminance, density, and a color difference.

In order to suppress the unevenness in the illuminance, the density, and the color difference, a technique for reading a white reference board, determining image data obtained when the white reference board is read, and changing a light amount is also conceivable. In the case of this method, correction control needs to be performed after a reading operation for the white reference board. Therefore, if a light amount fluctuates while an original document is read, it is impossible to cope with the fluctuation in the light amount.

### DESCRIPTION OF THE DRAWINGS

FIG. 1 is a diagram of a configuration example of an image forming apparatus according to a first embodiment;

FIG. 2A is a schematic diagram of a scanning optical system included in the image forming apparatus according to the first embodiment and a second embodiment;

FIG. 2B is a schematic diagram of another configuration example of the scanning optical system;

FIG. 3A is a schematic diagram of a configuration example of an LED light source unit according to the first and second embodiments;

FIG. 3B is a schematic diagram of a configuration example of the LED light source unit shown in FIG. 3A viewed from another point of view;

FIG. 4 is a block diagram of a hardware configuration example of the scanning optical system according to the first and second embodiments;

FIG. 5 is a flowchart for explaining an operation example according to the first embodiment;

FIG. 6 is a first flowchart for explaining another operation example according to the first embodiment;

FIG. 7 is a second flowchart for explaining still another operation example according to the first embodiment;

FIG. 8 is a flowchart for explaining an operation example according to the second embodiment;

FIG. 9 is a schematic diagram of a configuration example of an LED light source unit according to a third embodiment;

FIG. 10 is a diagram of an arrangement example of LED elements and a thermistor according to the third embodiment;

FIG. 11 is a diagram of an example of a control mechanism according to the third embodiment;

FIG. 12 is a schematic diagram of the configuration of a driver circuit according to the third embodiment;

FIG. 13 is a graph of a relation between environment temperature and a light amount;

FIG. 14 is a flowchart for explaining an operation example of initialization processing according to the third embodiment; and

FIG. 15 is a flowchart for explaining an operation example of document reading processing according to the third embodiment.

### DETAILED DESCRIPTION

In general, according to one embodiment, an image forming apparatus includes: at least one light source unit including a light emitting element that emits light in red, a light emitting element that emits light in green, and a light emitting element that emits light in blue; an image pickup section configured to receive, from a reference board on which light from the light source unit is irradiated, reflected light to pick up an image of the reference board; and a control section configured to control the light emitting elements of the light source unit to separately emit light, acquire separate data picked up by the image pickup section and cause a storing section to store the data, select data having a smallest luminance value among the separate data stored in the storing section, and control light amounts of all the light emitting elements of the light source unit with the selected data set as a reference.

Embodiments are explained below with reference to the accompanying drawings. First, an implementation example for controlling light emission of LED elements to prevent a light amount from becoming larger than the saturation level is explained in a first embodiment. A method of adjusting a light amount taking into account light emission to an original document having a level difference such as an original document obtained by sticking sheets is explained in a second embodiment. Lastly, a method of adjusting a light amount taking into account environment temperature is explained in a third embodiment.

### First Embodiment

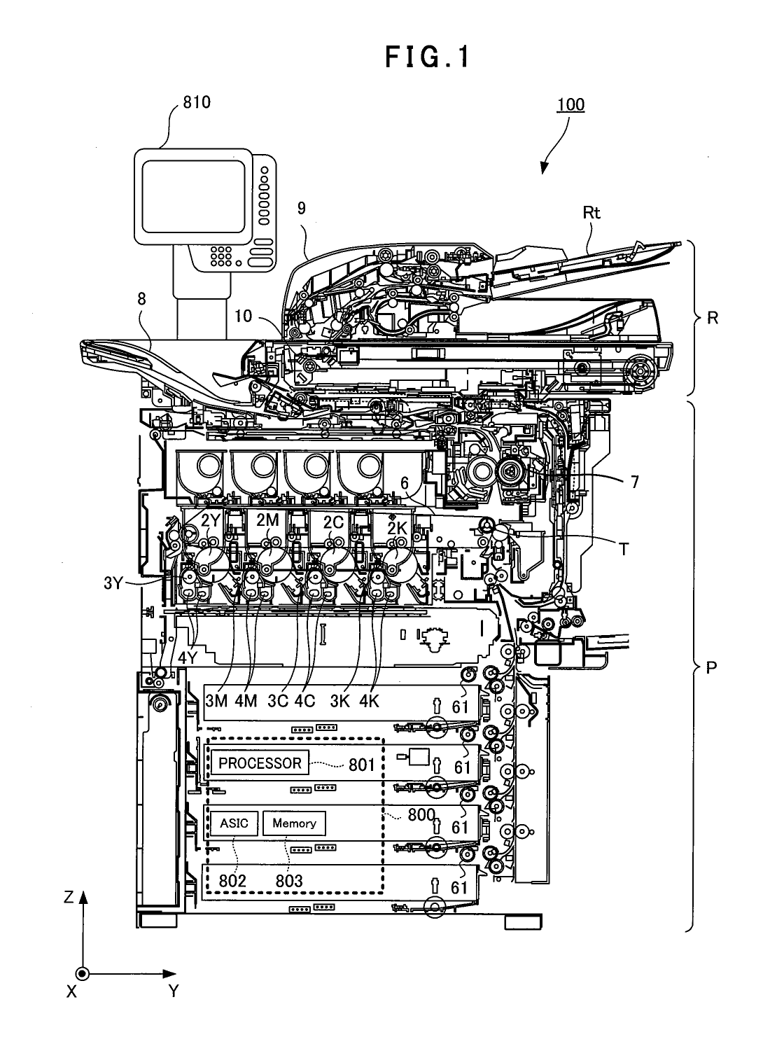

FIG. 1 is a longitudinal sectional view of a schematic configuration of an image forming apparatus (MFP: Multi Function Peripheral) according to a first embodiment. As shown in FIG. 1, an image forming apparatus 100 according to this embodiment includes a reading section R and an image forming section P.

The reading section R has a function of scanning and reading images of a sheet document and a book document. The reading section R includes a scanning optical system 10 including plural reflection mirrors and image pickup elements and includes an auto document feeder (ADF) 9 that can automatically feed an original document to a predetermined placing location. Images of an original document placed on a document tray Rt and automatically fed by the auto document feeder 9 and an original document placed on a document table are read by the scanning optical system 10. The configuration of the scanning optical system 10 is explained in detail later.

The image forming section P has a function of forming a developer image on a sheet on the basis of an image read from an original document by the reading section R, image data transmitted from an external apparatus to the image forming apparatus 100, or the like. The image forming section P includes photoconductive members 2Y to 2K, developing rollers 3Y to 3K, mixers 4Y to 4K, an intermediate transfer belt 6, a fixing device 7, and a discharge tray 8.

The image forming apparatus 100 includes a control board 800. The control board 800 includes a processor 801, which is an arithmetic processing device (e.g., a CPU (Central Processing Unit) or an MPU (Micro Processing Unit)), an ASIC (Application Specific Integrated Circuit) 802, and a memory 803 including a nonvolatile storage device (e.g., an FROM (Flash Read Only Memory) or a hard disk drive) and a volatile storage device (e.g., an SRAM (Static Random Access Memory), a DRAM (Dynamic Random Access Memory), or a VRAM (Video RAM)). The processor 801 has a role of performing various kinds of processing in the image forming apparatus 100 and also has a role of loading a computer program stored in advance in a nonvolatile storage area of the memory 803 to a volatile storage area of the memory 803 and executing the loaded computer program to thereby realize various functions. The memory 803 has a role of storing various kinds of information and computer programs used in the image forming apparatus 100.

The image forming apparatus 100 includes a control panel 810. The control panel 810 receives an instruction from a user and displays processing content to the user.

As an example of processing in the image forming apparatus 100 according to this embodiment, an overview of copy processing is explained.

First, a sheet picked up by a pickup roller 61 is fed into a sheet conveying path. The sheet fed into the sheet conveying path is conveyed in a predetermined conveying direction by plural roller pairs.

Images of plural sheet documents continuously automatically fed by the auto document feeder 9 are read by the scanning optical system 10.

The control board 800 applies predetermined image processing to image data read from the original documents in the reading section R. Thereafter, latent images of data after image processing are formed on photoconductive surfaces of the photoconductive members 2Y, 2M, 2C, and 2K for transferring developer images of Y (yellow), M (magenta), C (cyan), and K (black) onto the sheet.

Subsequently, developers agitated by the mixers 4Y to 4K in developing devices are supplied to the photoconductive members 2Y to 2K, on which the electrostatic latent images are formed as explained above, by the developing rollers (so-called magnet rollers) 3Y to 3K. Consequently, the electrostatic latent images formed on the photoconductive surfaces of the photoconductive members are visualized.

Developer images formed on the photoconductive members in this way are transferred onto the belt surface of the intermediate transfer belt 6 (so-called primary transfer). The developer images carried by the rotation of the intermediate transfer belt 6 are transferred onto conveyed sheets in a predetermined secondary transfer position T.

The developer images transferred onto the sheets are heated and fixed on the sheets by the fixing device 7. The sheets having the developer images heated and fixed thereon are conveyed through a conveying path by plural conveying roller pairs and sequentially discharged onto the discharge tray 8.

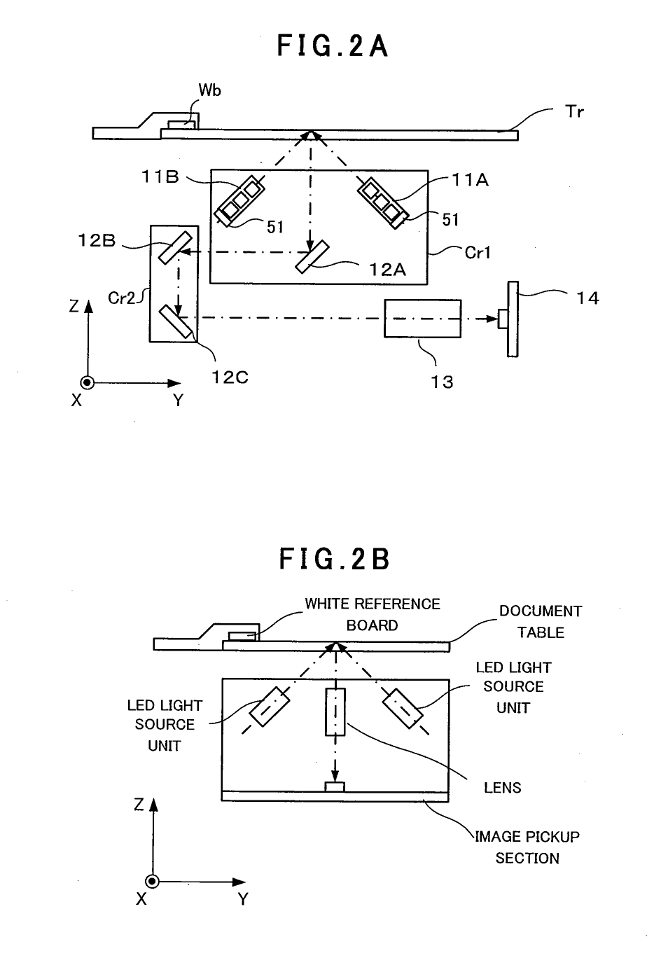

The configuration of the scanning optical system 10 is explained with reference to FIG. 2A. The scanning optical system 10 includes a document table Tr, two LED light source units 11A and 11B, reflection mirrors 12A to 12C, a lens 13, and an image pickup section 14. The LED light source units 11A and 11B are light emitting members arranged on both sides of an optical axis of light reflected from an original document and each having plural LED elements. The LED light source units 11A and 11B are arranged to be tilted to condense light in a fixed position on the document table Tr (right above the reflection mirror 12A). The image pickup section 14 includes a CCD sensor, which is an image pickup element, and a substrate configured to control the CCD sensor.

Lights emitted by the LED light source units 11A and 11B are reflected on an original document arranged in the document table Tr. Reflected light of the lights is made incident on the lens 13 through the reflection mirrors 12A to 12C. The lens 13 adjusts a focus of an image of the light made incident on the lens 13. The image pickup section 14 receives the image subjected to the focus adjustment by the lens 13 and photoelectrically converts (picks up) the image.

The LED light source units 11A and 11B and the reflection mirror 12A are included in a carriage Cr1. When the carriage Cr1 moves during document reading, the LED light source units 11A and 11B and the reflection mirror 12A move in a sub-scanning direction (a Y axis direction). Similarly, the reflection mirrors 12B and 12C are included in a carriage Cr2 and move in the sub-scanning direction.

The scanning optical system 10 includes a white reference board Wb serving as a white reference for adjustment.

A configuration example of a scanning optical system not including a reflection mirror is shown in FIG. 2B. In FIG. 2B, reflected light from an original document based on emitted lights from LED light source units is directly made incident on a lens and picked up by an image pickup section. The configuration shown in FIG. 2B may be adopted in this embodiment.

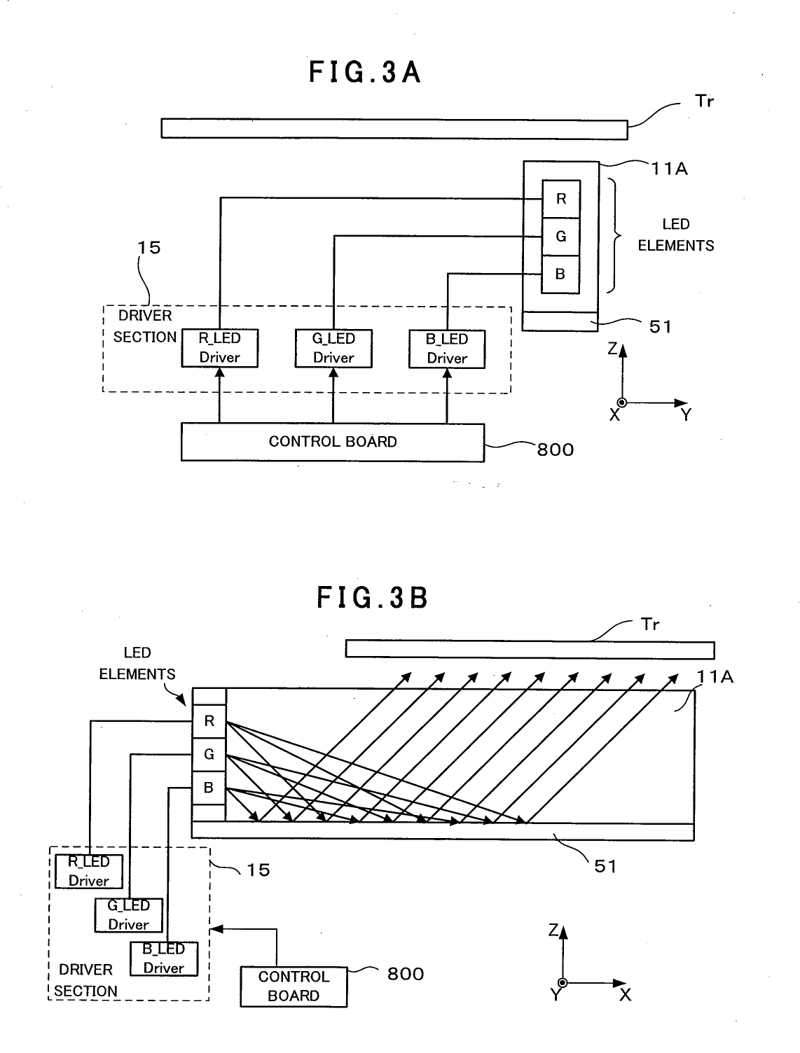

A detailed configuration of the LED light source unit according to this embodiment is explained below with reference to FIGS. 3A and 3B. In FIGS. 3A and 3B, a configuration example of the LED light source unit 11A is shown. However, the LED light source unit 11B is the same. FIG. 3A is a diagram of the LED light source unit 11A viewed such that a line of sight is parallel to a main scanning direction (an X axis direction) (a tilt of the LED light source unit 11A is omitted). FIG. 3B is a diagram of the LED light source unit 11A viewed such that a line of sight is parallel to the sub-scanning direction (the Y axis direction). The LED light source unit 11A includes LED elements for R, G, and B at an end in the main scanning direction (see FIG. 3B). The LED elements for R, G, and B emit lights to a light guide member 51 configured to reflect the lights to be made uniform. The lights made uniform by the light guide member 51 are made incident on the document table Tr (see FIG. 3B). The control board 800 outputs a turn-on signal, a turn-off signal, a control signal for an output light amount (hereinafter referred to as light amount signal) for the LED elements for R, G, and B to a driver section 15. The driver section 15 includes driver circuits (R_LED-Driver, G_LED-Driver, and B_LED-Driver) for the respective colors. The driver section 15 controls the LED elements corresponding to the respective driver circuits on the basis of a control signal from the control board 800. The driver section 15 is implemented as an ASIC.

In this embodiment, if the LED elements of the LED light source unit 11A are present, for example, at an end on the front side in the main scanning direction, in order to make irradiation on an original document uniform, the LED elements of the LED light source unit 11B are arranged at an end on the opposite side, i.e., in this example, the rear side in the main scanning direction.

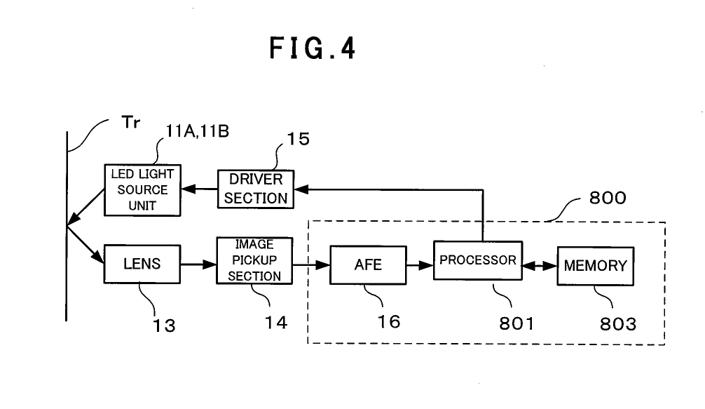

FIG. 4 is a hardware block diagram of an electric configuration of the reading section R. As shown in FIG. 4, the processor 801 outputs a turn-on signal and a light amount signal to the driver section 15. If the LED light source units 11A and 11B are turned off, the processor 801 outputs a turn-off signal to the driver section 15. The driver section 15 turns on the LED light source units 11A and 11B to have a light amount corresponding to the light amount signal. Light from the LED light source units 11A and 11B is reflected on a sheet document set on the document table Tr. The image pickup section 14 picks up, via the lens 13, reflected light from the sheet document, i.e., an image of the sheet document. An AFE 16 performs adjustment of analog front end offset (AFE) for the image to be picked up. Image pickup data after the adjustment is stored in the memory 803 via the processor 801. In this embodiment, output control for the turn-on and turn-off signals of the LED light source units 11A and 11B by the processor 801 and storage control for the image picked up by the image pickup section 14 are performed by the processor 801 executing an arithmetic operation of a computer program introduced in the memory 803 in advance.

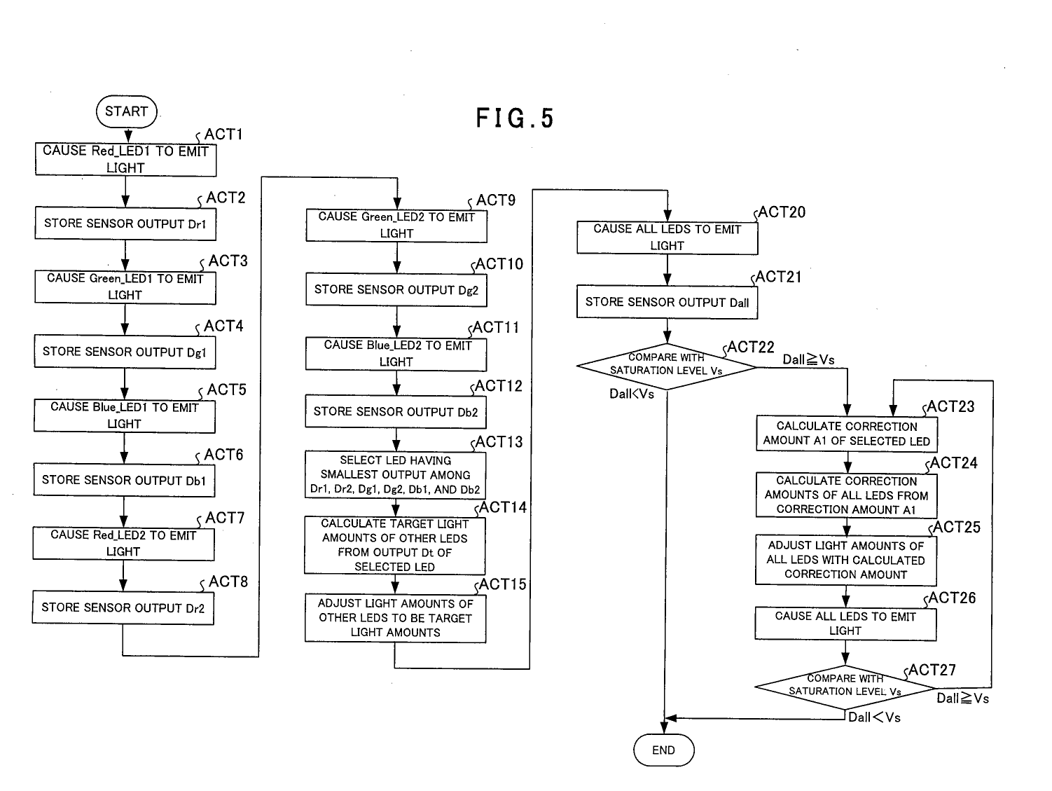

The operation of the image forming apparatus 100 according to this embodiment is explained below with reference to a flowchart of FIG. 5. An operation entity of the flowchart of FIG. 5 is mainly the processor 801.

The LED light source units 11A and 11B according to this embodiment have the configuration including the LED elements for R, G, and B in one LED light source unit as shown in FIGS. 3A and 3B. FIG. 5 is a control flow of control performed when the LED light source units 11A and 11B are arranged on both side of an optical axis of light reflected from a document sheet. Therefore, it is assumed that six LED elements in total are used in this example. The number of LED elements is not limited to this.

Rated conditions mean the following conditions:

an electric current flows at maximum rating specified for the LED elements; and

the LED elements do not periodically repeats light emission and non-light emission but continue to be caused to emit light until this control is ended (DC light emission).

In flowcharts referred to below in this embodiment, the LED elements for R, G, and B are respectively referred to as Red_LED, Green_LED, and Blue_LED. The LED elements and data corresponding to the LED light source unit 11A are denoted by reference signs with 1 attached to the ends of the reference signs in such a manner as Red_LED1, Green_LED1, and Blue_LED1. Similarly, the LED elements and data corresponding to the LED light source unit 11B are denoted by reference signs with 2 attached to the ends of the reference signs. The LED light source units 11A and 11B are explained as irradiating the white reference board Wb.

First, the processor 801 causes only the LED element Red_LED1 to emit light under the rated conditions (ACT 1). The image pickup section 14 photoelectrically converts reflected light of the light irradiated on the white reference board Wb. A signal level Dr1 of the photoelectrically-converted light is stored in the memory 803 (ACT 2).

Subsequently, the processor 801 causes only the LED element Green_LED1 to emit light under the rated conditions (ACT 3). The image pickup section 14 photoelectrically converts reflected light of the light irradiated on the white reference board Wb. A signal level Dg1 of the photoelectrically-converted light is stored in the memory 803 (ACT 4).

The processor 801 causes only the LED element Blue_LED1 to emit light under the rated conditions (ACT 5). The image pickup section 14 photoelectrically converts reflected light of the light irradiated on the white reference board Wb. A signal level Db1 of the photoelectrically-converted light is stored in the memory 803 (ACT 6).

Similarly, concerning the LED elements in the LED light source unit 11B, the processor 801 causes the LED elements Red_LED2, Green_LED2, and Blue_LED2 to separately emit light and causes the memory 803 to separately store signal levels Dr2, Dg2, and Db2 acquired by the image pickup section 14 (ACTS 7 to 12).

The processor 801 compares values (luminance values) of the signal levels stored in the memory 803 to select the LED element having a smallest output light amount among the six LED elements in total (ACT 13). The LED element selected in ACT 13 is hereinafter referred to as selected LED.

The processor 801 calculates, on the basis of an output level Dt of the selected LED, target light amounts of the other LED elements with the output level Dt set as a reference (ACT 14).

As a calculation example in ACT 14, a specific example is explained below in which a present relative ratio of light amounts of the LED elements is (Red_LED1):(Green_LED1):(Blue_LED1):(Red_LED2):(Green_LED2):(Blue_LED2)=2:9:5:4:7:3 and a requested relative ratio of light amounts of LEDs for red, green, and blue is 3:10:2. The requested ratio varies depending on a spectral characteristic of an LED, a spectral characteristic of an image pickup element, and a target spectral characteristic and is not determined as one ratio.

Since the LED having a low light amount among the LEDs is the LED element Red_LED1 (a ratio value is 2), in this embodiment, light amounts of the LEDs are adjusted with the LED element Red_LED1 set as a reference (100%). In order to adjust the light amounts to the requested ratio, light amount adjustment only has to be performed such that a ratio of the following formula holds:

(present value of the selected LED):(requested value of the selected LED)=(value of a calculation target LED):(requested value of the calculation target LED)

For example, if a light amount of (Green_LED1) is adjusted, an adjustment amount X is calculated as follows:

2:3=9×X:10

X=2×10÷3÷9≡0.74

The processor 801 adjusts (Green_LED1) to be 74% of a present light amount of (Green_LED1).

If a light amount of (Blue_LED2) is adjusted, an adjustment amount X is calculated as follows:

2:3=3×X:2

X=2×2÷3÷3≡0.44

The processor 801 adjusts (Blue_LED2) to be 44% of a present light amount of (Blue_LED2).

According to such calculation, an adjustment amount (%) is calculated as follows:

an adjustment amount for Red_LED1 is 100%;

an adjustment amount for Green_LED1 is about 74%;

an adjustment amount for Blue_LED1 is about 27%;

an adjustment amount for Red_LED2 is about 50%;

an adjustment amount for Green_LED2 is about 95%; and

an adjustment amount for Blue_LED2 is about 44%.

The processor 801 outputs light amount signals such that the LED elements have light amounts corresponding to the calculated adjustment amounts (ACT 15). Since a light amount of an LED element and a current value has a substantial proportional relation, the LED elements are adjusted to have current values corresponding to the adjustment amounts (%). The adjustment of the LED element is performed by the driver section 15 changing a current amount of a forward current of the LED element. Control of the current amount is based on a light amount signal from the processor 801.

By adopting such a configuration and operations, it is possible to set all the LED elements to requested light amounts. With the LED element having a smallest light amount set as a reference, light amounts of the other LED elements are adjusted. Therefore, an entire light amount decreases and adjustment for not exceeding a saturation level of the image pickup section 14 can be expected.

However, only with the control in ACTS 1 to 15, it is still likely that the saturation level of the image pickup section 14 is exceeded. Therefore, as explained below, after performing the adjustment in ACT 15, the image forming apparatus 100 turns on all the LED elements and checks whether the saturation level is exceeded. The white reference board Wb is used for processing explained below as well.

The processor 801 causes all the LED elements to emit light (ACT 20) and causes the memory 803 to store a signal level Dall of the light photoelectrically converted by the image pickup section 14 (ACT 21). The processor 801 compares a value Vs of the saturation level defined in advance and the signal level Dall (ACT 22). If the signal level Dall is smaller than the saturation level Vs (Dall<Vs in ACT 22), the processing ends.

On the other hand, if the signal level Dall is equal to or larger than the saturation level Vs (Dall≧Vs in ACT 22), the processor 801 calculates a correction amount A1 of the selected LED (ACT 23). As a method of calculating a correction amount, it is conceivable to adopt, for example, a method of calculating a ratio (Vs/Dall) of the saturation level Vs and the signal level Dall and integrating a calculated value and a light amount of the selected LED to obtain the correction amount A1. Concerning the other LE elements, similarly, the processor 801 integrates ratios (Vs/Dall) and light amounts of the LED elements (ACT 24). In ACT 24, the processor 801 may calculate optimum light amount ratios of all the LED elements as in the processing in ACT 14 with the correction amount A1 of the selected LED set as a reference and taking into account ratios from the correction amount A1.

As another implementation of ACTS 23 and 24, for example, binary search may be performed such that the signal level Dall approximates to the saturation level Vs.

The processor 801 adjusts light amounts such that all the LED elements are turned on with a calculated correction amount (ACT 25), outputs a light amount signal corresponding to the correction amount, and causes all the LED elements to emit light (ACT 26).

The processor 801 compares the present light amount (Dall) and the saturation level Vs again (ACT 27). If the light amount Dall is smaller than the saturation level Vs (Dall<Vs in ACT 27), the processing ends. On the other hand, if the light amount Dall is equal to or larger than the saturation level Vs (Dall≧Vs in ACT 27), the processing returns to ACT 23 and calculation of a correction amount is performed again.

By performing such an operation, when all the LED elements emit light, it is possible to prevent a light amount from exceeding a saturation level of a CCD sensor.

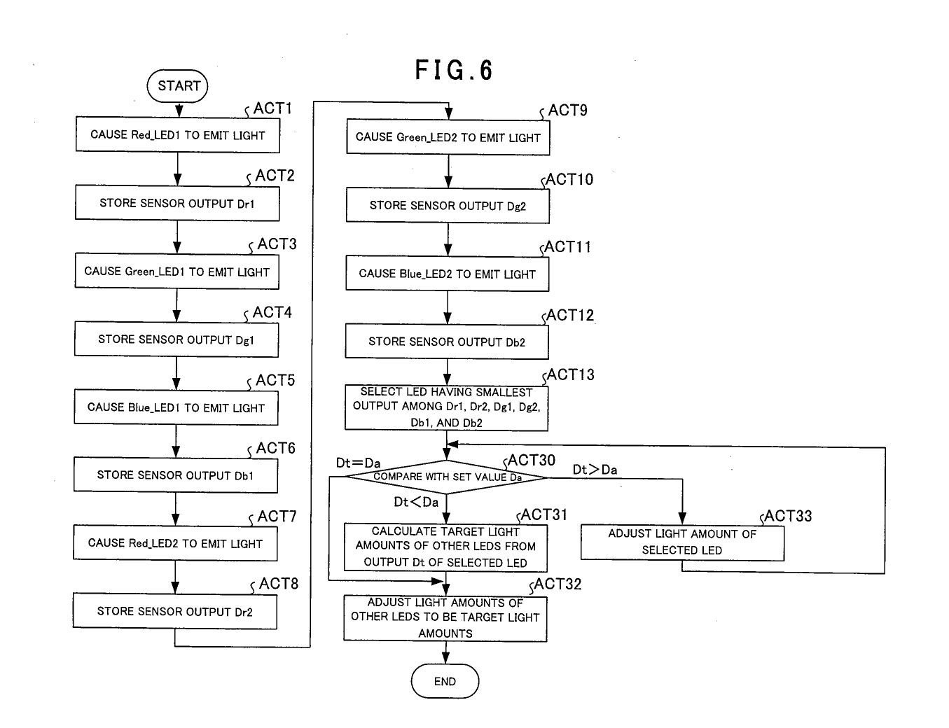

FIG. 6 is a diagram of another example of the operation shown in FIG. 5. The example shown in FIG. 6 is implementation for performing comparison processing of a predetermined set value with the signal level (Dt) of the selected LED to prevent the light amount (Dall) of all the LED elements from exceeding the saturation level.

An operation from ACTS 1 to 13 is the same as that shown in FIG. 5. Therefore, explanation of the operation is omitted. After determining the selected LED, which is the LED element having the smallest signal level, in ACT 13, the processor 801 compares the signal level Dt of the selected LED and the set value Da (ACT 30). The set value Da is a value defined in advance such that a light amount does not exceed the saturation level when all the LED elements emit light.

If the signal level Dt is the same as the set value Da (Dt=Da in ACT 30), the processing proceeds to ACT 32. If the signal level Dt is larger than the set value Da (Dt>Da in ACT 30), the processor 801 adjusts a light amount of the selected LED (ACT 33) and performs the comparison processing again (to ACT 30). In ACT 33, for example, the processor 801 sets the signal level Dt to be a value smaller than the set value Da. If the signal level Dt is smaller than the set value Da (Dt<Da in ACT 30), the processor 801 calculates, in processing same as ACT 14 shown in FIG. 5, target light amounts of the other LED elements from the signal level Dt of the selected LED (ACT 31). Thereafter, as in the processing in ACT 15, the processor 801 adjusts the other LED elements to have the target light amounts (ACT 32).

With such a configuration, it is possible to control a light amount of all the LED elements not to exceed the saturation level of the image pickup section 14.

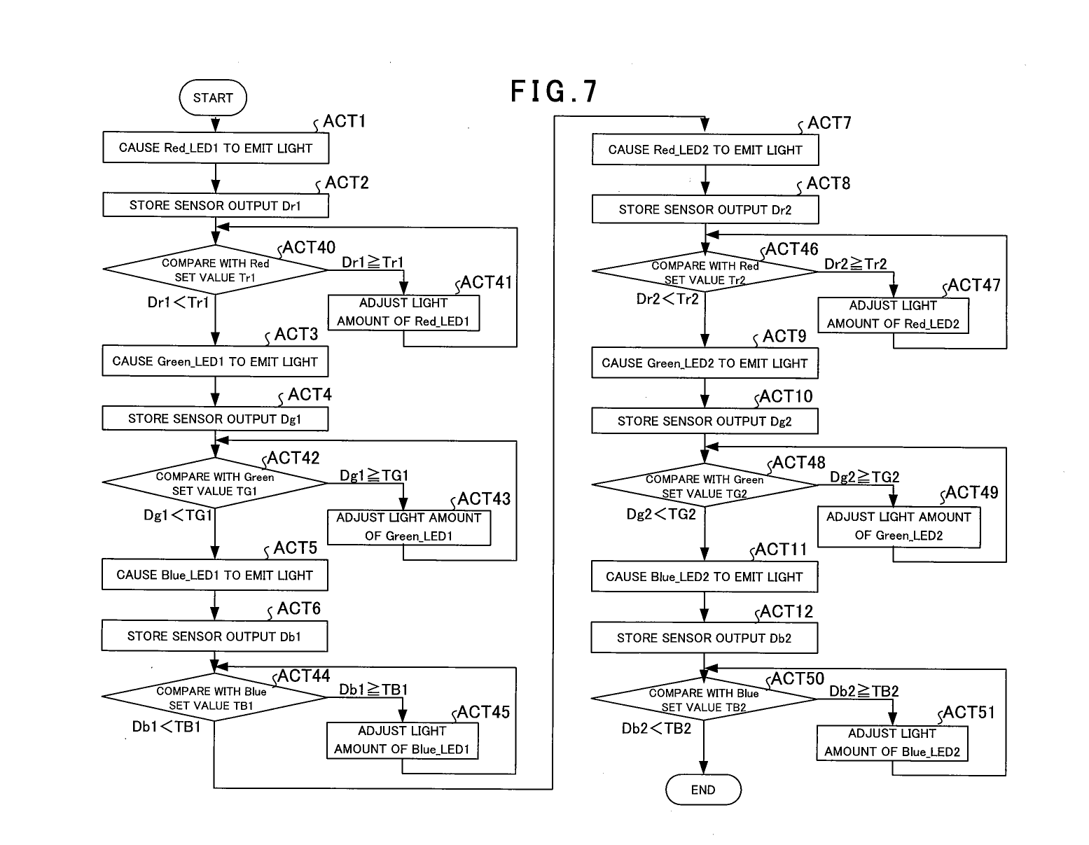

In FIG. 7, as another example, an implementation example for causing each of the LED elements to emit light and comparing a light amount of each of the LED elements with a set value is shown.

As in FIGS. 5 and 6, the processor 801 causes only the LED element Red_LED1 to emit light under the rated conditions (ACT 1). The image pickup section 14 photoelectrically converts reflected light from the white reference board Wb. A signal level Dr1 of the photoelectrically-converted light is stored in the memory 803 (ACT 2). The processor 801 compares a specified value Tr1 of the LED element Red_LED1 defined in advance and the signal level Dr1 (ACT 40). If the signal level Dr1 is equal to or larger than the specified value Tr1 (Dr1≧Tr1 in ACT 40), the processor 801 adjusts a light amount of the LED element Red_LED1 (ACT 41) and executes the determination processing in ACT 40 again. A method of the adjustment in ACT 41 is the same as that in ACT 33.

If the signal level Dr1 is smaller than the specified value Tr1 (Dr1<Tr1 in ACT 40), subsequently, concerning the LED element Green_LED1, the processor 801 executes the processing of the light emission control (ACT 3), the storage of the signal level Dg1 (ACT 4), comparison with a set value TG1 (ACT 42), and adjustment (ACT 43). Thereafter, the processor 801 performs the same processing concerning all the LED elements (ACTS 5 to 51).

With such an operation, as in the operation explained above, it is possible to perform light amount adjustment for not exceeding the saturation level of the image pickup section 14.

In the first embodiment, details of implementation explained below are explained.

1. The LED element having a smallest light amount when caused to emit light under the rated conditions is extracted. Light amounts of the other LED elements are adjusted with the light amount of the extracted LED element set as a reference.
2. After the light amounts of the other LED elements are adjusted according to an output value of the extracted LED element (the selected LED) having the smallest light amount when caused to emit light under the rated conditions, if a value obtained by adding up all the light amounts exceeds the saturation level of the image pickup element, the light amount of the selected LED is reduced to a level not saturating during light emission of all the LED elements.
3. If the output value of the extracted LED element (the selected LED) having the smallest light amount when caused to emit light under the rated conditions is larger than an output value set in advance, the light amount of the LED element is adjusted to be a numerical value set in advance. Light amounts of the other LED elements are adjusted with the light amount of the selected LED after the light amount adjustment set as a reference.
4. Light amount adjustment is performed for each of the LED elements such that the LED elements have adjustment target values set in advance.
5. The light amounts of the LED elements are adjusted such that an output level of the image pickup element obtained when the white reference board is read reaches a predetermined value.

DC light emission is explained in the example explained above. However, pulse light emission for maximizing a reading time for one line of the image pickup section 14 and performing light emission and non-light emission of a light source in the reading time for one line may be performed. In this case, the processor 801 changes a light emission time while reading one line and adjusts the LED elements. When the change and the adjustment are performed in this way, the processor 801 performs an operation for turning on and off the LED elements on the outside of a valid image area.

In this embodiment, the two LED light source units are provided. However, this does not limit a form of the LED light source units. Two or more LED light source units or one LED light source unit may be provided.

### Second Embodiment

In the first embodiment, the method of separately turning on and adjusting the LED elements of the LED light source units 11A and 11B is explained. In the form of the first embodiment, it is likely that a difference occurs in a light amount between light emission of the LED light source unit 11A and light emission of the LED light source unit 11B. If a difference occurs in a light amount, for example, when an original document having a level difference such as a stuck document is read, it is likely that a shadow is formed by the level difference.

In a second embodiment, an implementation example for solving this problem is explained. A hardware configuration and the like are the same as those in the first embodiment. Therefore, explanation of the hardware configuration and the like is omitted (see FIGS. 1 to 4).

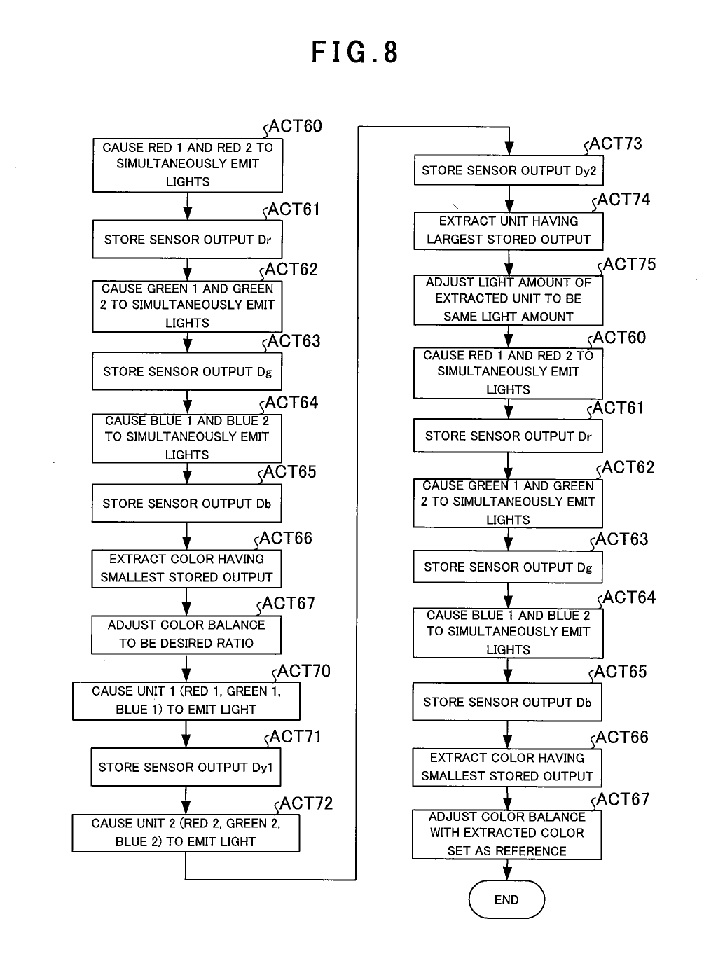

FIG. 8 is a flowchart for explaining an operation example of light amount adjustment for the LED light source units 11A and 11B in this embodiment. In the following explanation of the flowchart of FIG. 8, it is assumed that the processor 801 mainly performs control as in the first embodiment. In the explanation of FIG. 8, notations red 1, green 1, and blue 1 respectively mean a red LED element, a green LED element, and a blue LED element of the LED light source unit 11A. Notations red 2, green 2, and blue 2 respectively mean a red LED element, a green LED element, and a blue LED element of the LED light source unit 11B.

The processor 801 causes the red LED element of the LED light source unit 11A and the red LED element of the LED light source unit 11B to simultaneously emit lights (ACT 60). The image pickup section 14 picks up an image at this point. Image pickup data (a signal level Dr) is stored in the memory 803 (ACT 61).

Similarly, the processor 801 causes the green LED elements of the LED light source units 11A and 11B to simultaneously emit lights (ACT 62) and causes the memory 803 to store a signal level Dg at this point (ACT 63). The processor 801 causes the blue LED elements of the LED light source units 11A and 11B to simultaneously emit lights (ACT 64) and causes the memory 803 to store a signal level Db at this point (ACT 65).

The processor 801 extracts a signal level having a smallest luminance value among the signal levels Dr, Dg, and Db stored in the memory 803 (ACT 66). Thereafter, the processor 801 performs adjustment with the extracted LED element having the smallest value set as a reference and adjusts a color balance such that red, green, and blue are mixed at a desired ratio (ACT 67). This adjustment processing can be performed according to the same idea as ACT 14.

With this operation, it is possible to realize a desired color balance in a short time. However, in order to suppress the occurrence of a shadow, in the second embodiment, processing explained below is continuously performed to suppress light amount fluctuation between the LED light source units 11A and 11B.

Subsequently, the processor 801 causes the LED elements (red, green, and blue) in the LED light source unit 11A to simultaneously emit lights (turns off the LED light source unit 11B) (ACT 70) and causes the memory 803 to store a signal level Dy1 at this point (ACT 71). The processor 801 causes the LED elements (red, green, and blue) in the LED light source unit 11B to simultaneously emit lights (turns off the LED light source unit 11A) (ACT 72) and causes the memory 803 to store a signal level Dy2 at this point (ACT 73).

The processor 801 extracts the LED light source unit having a larger luminance value among the stored signal levels Dy1 and Dy2 (ACT 74). The processor 801 adjusts a light amount of the LED light source unit having a larger output to be an output value same as an output value of the LED light source unit having a smaller output (ACT 75). For example, if a light amount of the LED light source unit 11A is larger, the processor 801 calculates a light amount ratio ((light amount of the unit 11B)/(light amount of the unit 11A)) and adjusts a present current value flowing to the LED light source unit 11A to be suppressed by the light amount ratio.

This makes it possible to balance light amounts between the LED light source units 11A and 11B. However, on the contrary, it is likely that a color balance among red, green, and blue is lost. To eliminate the shift of the color balance, in this embodiment, the processing in ACTS 60 to 67 is carried out again as shown in FIG. 8 (see above for details).

The explanation in the second embodiment is summarized as explained below.

1. When the LED light source units having the plural LED elements for red, green, and blue are arranged on both sides of an optical axis of light reflected from an original document, the LED elements of the same colors of the units simultaneously emit lights and the image pickup section picks up an image, whereby signal levels for the respective colors are obtained. The signal level having a lowest value among the obtained signal levels is selected. Light amounts of the other colors are adjusted with this signal level set as a reference.
2. After the light amount adjustment for the respective colors, the LED elements in the LED light source unit having a larger light amount are further adjusted such that a light amount obtained when the LED elements (red, green, and blue) included in one LED light source unit are caused to simultaneously emit lights and a light amount obtained when the LED elements included in the other LED light source unit are caused to simultaneously emit lights are the same.

According to this embodiment, it is possible to cancel a difference in a light amount for each of the colors and a difference in light amount between the LED light source units.

### Third Embodiment

In a third embodiment, an implementation example for measuring environment temperature near LED light source units and adjusting a light amount of LED elements on the basis of the temperature is explained. A hardware configuration and the like other than items explained below are the same as those in the first embodiment. Therefore, explanation of the hardware configuration and the like is omitted (see FIGS. 1 to 4).

The reading section R according to this embodiment has a configuration explained below.

The reading section R includes at least one or more means for detecting environment temperature near the LED light source units.

The reading section R has a circuit configuration for controlling, using one or more LED driving circuits, at least two or more LED arrays mounted on a substrate in each of the driving circuits and increasing or decreasing an electric current fed to the LED arrays.

The reading section includes a control program for increasing or decreasing, according to a change in the environment temperature, the electric current flowing to the LED arrays.

The reading section includes a control program for, when the environment temperature changes, even during reading of the same page, increasing or decreasing the electric current fed to the LED arrays and keeping light amounts of the LEDs constant.

A form of this embodiment is explained below with reference to the drawings.

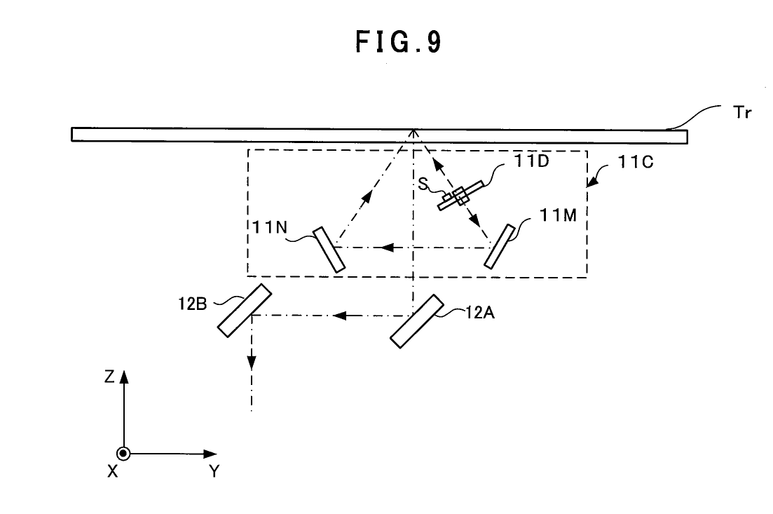

First, an example of an LED light source unit according to this embodiment is shown in FIG. 9. An LED light source unit 11C includes an LED substrate 11D and reflection mirrors 11M and 11N. The LED substrate 11D includes, on the front surface and the rear surface of the substrate, LED arrays in which plural LED elements are arrayed. Turn-on, turn-off, and a light amount of each of the LED elements in the LED substrate 11D are controlled on the basis of control by the control board 800. The LED array arranged on the front surface of the LED substrate 11D directly emits light to the document table Tr. On the other hand, light from the LED array arranged on the rear surface is made incident on the document table Tr through the reflection mirrors 11M and 11N. Tilts of the LED substrate 11D and the reflection mirrors 11M and 11N are adjusted such that the direct light from the LED elements on the front surface and the light from the LED elements on the rear surface through the reflection mirrors 11M and 11N are condensed in the same position on the document table Tr.

An original document on the document table Tr is irradiated by the emitted light of the LED light source unit 11C. Thereafter, as in the first and second embodiments, reflected light from the original document is received by the image pickup section 14 through the reflection mirrors 12A and 12B and the like.

The LED substrate 11D includes, on the front surface of the substrate, a thermistor S configured to measure environment temperature of the LED elements.

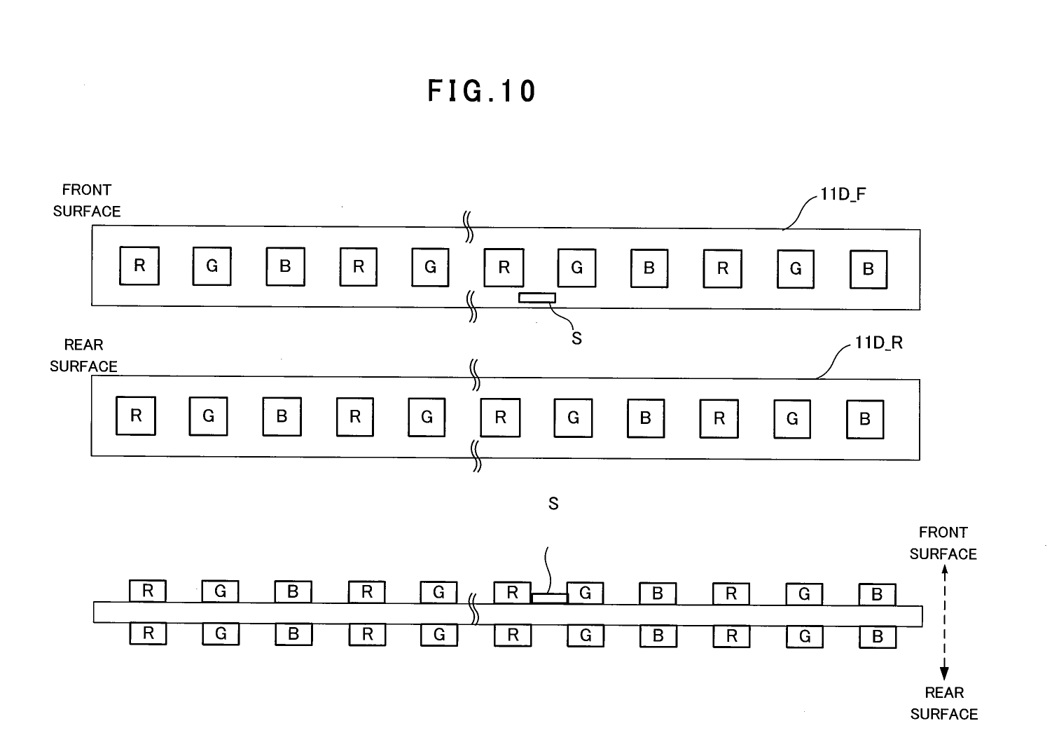

An example of details of the LED substrate 11D is shown in FIG. 10. On both a substrate front surface (11D_F) and a substrate rear surface (11D_R) of the LED substrate 11D, LED elements for the respective colors of R, G, and B are arranged in a row. The LED substrate 11D includes the thermistor S on the front surface 11D_F. The thermistor S may be arranged on the rear surface 11D_R or plural thermistors may be arranged. In this embodiment, the thermistor S is provided on the substrate of the LED substrate 11D. However, this does not limit a form of the thermistor S. The thermistor S may be arranged in anyplace as long as environment temperature near the LED elements can be measured.

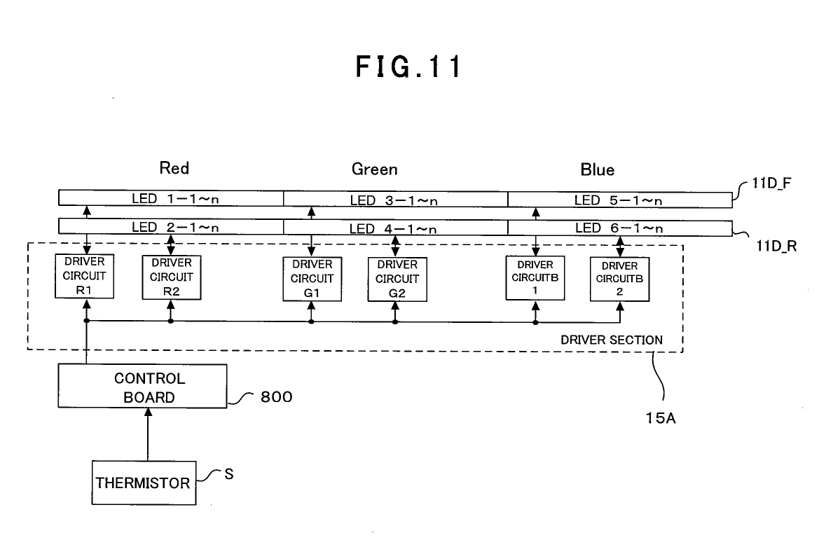

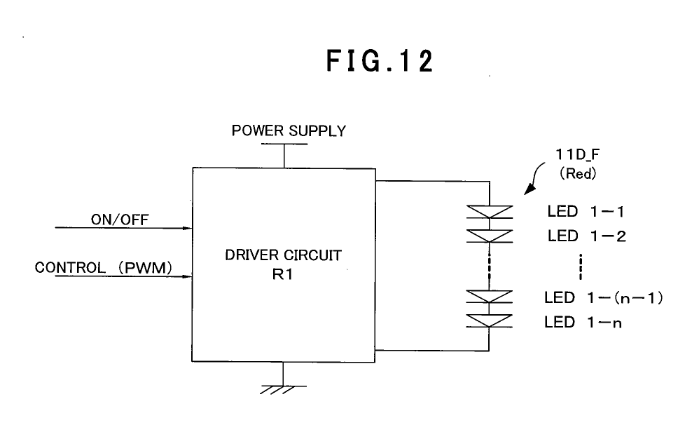

An overview of a circuit configured to control turn-on, turn-off, and a light amount of the LED light source unit 11C is shown in FIG. 11. An overview of a driver circuit for the LED light source unit 11C is shown in FIG. 12. In FIG. 12, a driver circuit for a red LED element on the substrate surface 11D_F is shown as an example.

The control board 800 separately controls, through a driver section 15A, red LED elements, green LED elements, and blue LED elements on the substrate front surface 11D_F and separately controls, through the driver section 15A, red LED elements, green LED elements, and blue LED elements on the substrate rear surface 11D_R.

As shown in FIG. 11, the red LED elements (in FIGS. 11 and 12, represented as LEDs 1-1 to n, the same applies in the following explanation), the green LED elements (LEDs 3-1 to n), and the blue LED elements (LEDs 5-1 to n) on the substrate front surface 11D_F are respectively controlled by driver circuits R1, G1, and B1 of the driver section 15A. Similarly, the red LED elements (LEDs 2-1 to n), the green LED elements (LEDs 4-1 to n), and the blue LED elements (LEDs 6-1 to n) on the substrate rear surface 11D_R are respectively controlled by driver circuits R2, G2, and B2.

The driver circuits receive input of ON and OFF signals for turning on and off the LED arrays and a control signal for controlling light emission of the LED elements by controlling a current amount through pulse width modulation from the control board 800 (see FIG. 12). The driver circuits receive input of a voltage value as a control signal to control a current amount flowing to the LED elements. The processor 801 manages overall control.

As shown in FIG. 11, the control board 800 receives input of a resistance change of the thermistor S in a form of voltage detection and detects environment temperature.

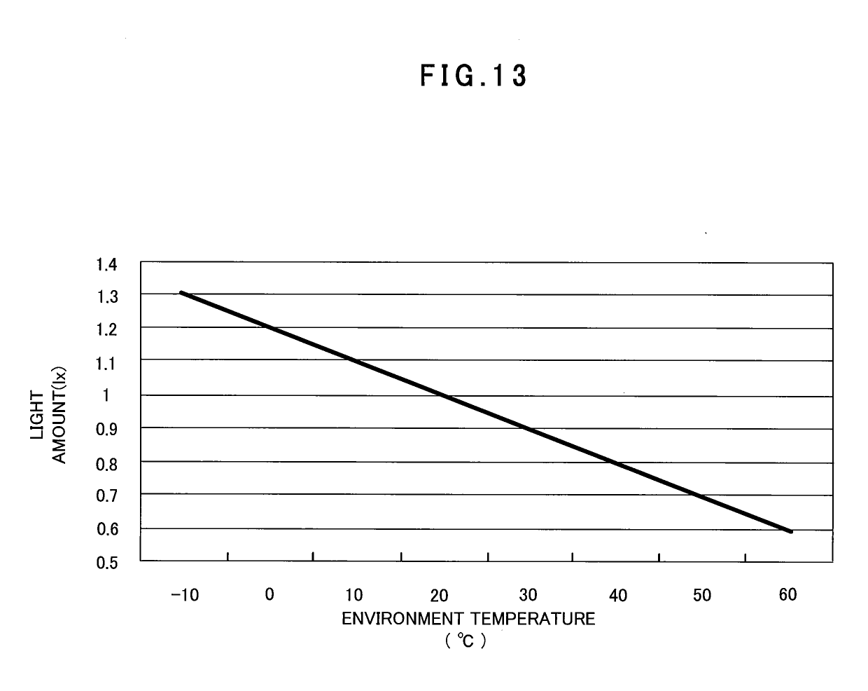

FIG. 13 is a graph of a relation between environment temperature and a light amount of an LED element. As it is seen from FIG. 13, the LED element has a characteristic that the light amount decreases every time the environment temperature rises. If the control in this embodiment is not performed, even if an electric current to the LED element is set to a fixed value, irradiated light from the LED element fluctuates according to fluctuation in the environment temperature. Unevenness occurs in illuminance, density, and a color difference. Therefore, in this embodiment, control of the light amount is performed to prevent unevenness in illuminance, density, and a color difference based on a light amount of a light source.

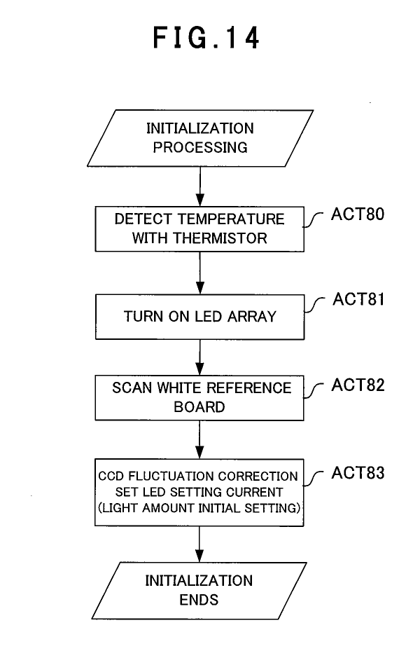

Initialization processing of the scanning optical system 10 according to this embodiment is explained with reference to FIG. 14.

First, the control board 800 detects initial environment temperature using the thermistor S (ACT 80). The control board 800 turns on all the LED elements (ACT 81) and carries out reading of the white reference board Wb (ACT 82). The control board 800 performs processing for correcting fluctuation caused in the image pickup section 14 and sets a current value to the LED elements on the basis of a correspondence table of a read value of the white reference board Wb and a current value of the LED elements stored in the memory 803 in advance (ACT 83). The fluctuation correction in the image pickup section 14 is performed according to a technique in the past.

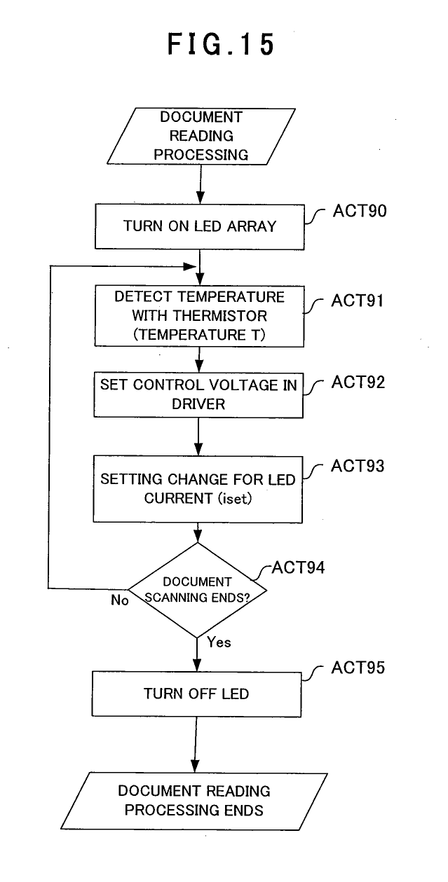

Operation processing during document reading is explained with reference to a flowchart of FIG. 15.

The control board 800 turns on all the LED elements (ACT 90) and performs temperature detection using the thermistor S (ACT 91). Detected temperature is represented as T. The control board 800 sets a control voltage to the driver section 15A on the basis of the detected temperature T and outputs a control signal to the driver section 15A at the voltage (ACT 92). The driver section 15A controls an electric current of the LED elements to be a current value corresponding to the control signal (ACT 93).

Operations in ACTS 92 and 93 are explained. The control board 800 calculates, using the following formula, a current value (iset) fed to the LED elements:

iset=1/itemp×i

where, “itemp” represents a light amount relative ratio at detected environment temperature when a light amount at reference temperature (in this embodiment, 20° C.) is set to 1. As shown in FIG. 13, if the detected temperature T is, for example, 30° C., a value of “itemp” is 0.9. If the detected temperature T is, for example, 10° C., a value of “itemp” is 1.1. In this embodiment, an inverse (1/itemp) of “itemp” is used to set a current value during a corresponding environment. Therefore, the control board 800 controls a light amount to increase as detected temperature is higher and controls the light amount to decrease as detected temperature is lower to keep the light amount constant irrespective of a temperature change. “i” in the formula is a constant and is a current value at the reference temperature (the temperature 20° C.).

The control board 800 outputs a voltage signal (a control signal) corresponding to the calculated value of iset to the driver section 15A. The LED elements in the LED light source unit 11C emit light at a light amount corresponding to the control signal.

Thereafter, the control board 800 determines whether document reading ends (ACT 94). If the document reading does not end (No in ACT 94), the processing returns to the temperature detection processing in ACT 91. Temperature detection in the thermistor S is continued until the document reading is completed. Therefore, correction processing can be carried out on a real time basis. If the document reading ends (Yes in ACT 94), the control board 800 performs control to turn off the LED elements (ACT 95) and the processing ends.

According to this embodiment, even if environment temperature near the LED elements changes, it is possible to carry out control for keeping a light amount constant and suppress occurrence of unevenness in illuminance, density, and a color difference on a real time basis. Therefore, it is possible to provide a light source for image reading and an image reading apparatus having quality higher than in the past.

An image reading apparatus and an image forming apparatus including all the functions explained in the first to third embodiments may be provided. An image reading apparatus and an image forming apparatus separately including the functions may be provided.

The control board 800 and the driver sections 15 and 15A explained in the first to third embodiments may be provided as a control section.

As explained above in detail, according to the technique described in this specification, the LED elements are turned on separately or for each of the colors and light amounts of the LED elements are adjusted on the basis of the LED element having a smallest light amount. Therefore, it is possible to control the LED elements to have an optimum light amount. Temperature near the LED elements can be detected and a light amount of the LED elements can be adjusted on a real time basis on the basis of the detected temperature. Therefore, it is possible to perform image formation higher in quality than in the past.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
at least one light source unit including a light emitting element that emits light in red, a light emitting element that emits light in green, and a light emitting element that emits light in blue;
an image pickup section configured to receive, from a reference board on which light from the light source unit is irradiated, reflected light of the light to pick up an image of the reference board; and
a control section configured to control the light emitting elements of the light source unit to separately emit light, acquire separate data picked up by the image pickup section and cause a storing section to store the data, select data having a smallest luminance value among the separate data stored in the storing section, and control light amounts of all the light emitting elements of the light source unit with the selected data set as a reference.

2. The apparatus according to claim 1, wherein
the control section further controls, after controlling the light amounts of all the light emitting elements, all the light emitting elements of the light source unit to be turned on,
the image pickup section picks up an image of a state when all the light emitting elements are turned on, and
if a value of data, which is obtained when all the light emitting elements are turned on, picked up by the image pickup section exceeds a specified value indicating a saturation level, which is a limit of luminance identification of the image pickup section, the control section controls, on the basis of the value of the data obtained when all the light emitting elements are turned on and the specified value, a light amount obtained when all the light emitting elements emit light to be smaller than the saturation level.

3. The apparatus according to claim 1 wherein, if a value of the selected data is larger than a specified value, the control section controls a light amount of the light emitting element corresponding to the selected data such that the value of the selected data decreases to be a value smaller than the specified value.

4. The apparatus according to claim 1, wherein the light source unit includes a first light source unit and a second light source unit, and the first light source unit and the second light source unit are arranged on both sides of an optical axis of light reflected from an original document.

5. The apparatus according to claim 4, wherein the control section causes the first light source unit and the second light source unit to simultaneously emit lights for each of the colors, causes the image pickup section to pick up an image for each of the colors, selects data having a smallest luminance value among three data of the simultaneously-emitted lights for each of the colors picked up by the image pickup section, and controls the light amounts of all the light emitting elements of the light source unit with the selected data set as a reference.

6. The apparatus according to claim 4, wherein the control section causes all the light emitting elements in the first light source unit to emit light and turns off all the light emitting elements in the second light source unit, causes the storing section to store first data, which is image pickup data of a state of the light emitting elements, causes all the light emitting elements in the second light source unit to emit light and turns off all the light emitting elements in the first light source unit, causes the storing section to store second data, which is image pickup data of a state of the light emitting elements, and controls a light amount of the light source unit having a larger value such that, of the first data and the second data stored in the storing section, the data having a larger value has a value of the other data.

7. The apparatus according to claim 6, wherein the control section further causes the first light source unit and the second light source unit to simultaneously emit light for each of the colors, causes the image pickup section to pick up an image for each of the colors, selects data having a smallest luminance value among three data of the simultaneously-emitted lights for each of the colors picked up by the image pickup section, and controls the light amounts of all the light emitting elements of the light source unit with the selected data set as a reference.

8. The apparatus according to claim 1, wherein the light emitting elements of the light source unit are LED elements.

9. An image forming apparatus comprising:
a light source unit including plural light emitting elements;
a temperature detecting section included in the light source unit and configured to detect temperature; and
a control section configured to control the light source unit such that the light source unit is turned on when an original document is read and controls a light amount of the light source unit on the basis of the temperature detected by the temperature detecting section.

10. The apparatus according to claim 9, wherein the light source unit includes:
a reflection mirror; and
a substrate including, on one surface, a first array, in which plural light emitting elements are arrayed, configured to directly irradiate the original document and including, on the other surface, a second array, in which plural light emitting elements are arrayed, configured to irradiate light on the reflection mirror and irradiate the original document with reflected light of the reflection mirror.

11. The apparatus according to claim 9, wherein the control section controls, while the original document is read, a light amount of the light source unit on the basis of the temperature detected by the temperature detecting section.

12. The apparatus according to claim 9, wherein the control section controls a light amount of the light source unit to be kept constant.

13. The apparatus according to claim 9, wherein the control section controls a light amount of the light source unit to increase as the temperature detected by the temperature detecting section is higher and controls the light amount of the light source unit to decrease as the detected temperature is lower.

14. The apparatus according to claim 9, wherein the control section controls an electric current to flow to the light source unit at a value (iset) calculated by a following formula:
iset=1/itemp×i
where, “itemp” represents a value of a light amount at the temperature detected by the temperature detecting section when a value of a light amount at reference temperature is set to 1 and “i” represents a current value at the reference temperature.

15. A light amount adjusting method for an image forming apparatus including at least one light source unit including a light emitting element that emits light in red, a light emitting element that emits light in green, and a light emitting element that emits light in blue, the method comprising:
the image forming apparatus causing the light emitting elements of the light source unit to separately emit light to a reference board;
the image forming apparatus picking up, every time the light emitting elements separately emit light, an image of reflected light from the reference board;
the image forming apparatus acquiring picked-up separate data and causing a storing section to store the data; and
the image forming apparatus selecting data having a smallest luminance value among the separate data stored in the storing section and controlling light amounts of all the light emitting elements of the light source unit with the selected data set as a reference.

16. The method according to claim 15, wherein the image forming apparatus further controls, after controlling the light amounts of all the light emitting elements, all the light emitting elements of the light source unit to be turned on, picks up an image of a state when all the light emitting elements are turned on, and, if a value of picked-up data obtained when all the light emitting elements are turned on exceeds a specified value indicating a saturation level, which is a limit of luminance identification, controls, on the basis of the value of the data obtained when all the light emitting elements are turned on and the specified value, a light amount obtained when all the light emitting elements are turned on to be smaller than the saturation level.

17. The method according to claim 15 wherein, if a value of the selected data is larger than a specified value, the image forming apparatus controls a light amount of the light emitting element corresponding to the selected data such that the value of the selected data decreases to be a value smaller than the specified value.

18. The method according to claim 15, wherein
the light source unit includes a first light source unit and a second light source unit, and the first light source unit and the second light source unit are arranged on both sides of an optical axis of light reflected from an original document, and
the image forming apparatus causes the first light source unit and the second light source unit to simultaneously emit lights for each of the colors, picks up an image for each of the colors, selects data having a smallest luminance value among picked-up three data of the simultaneously-emitted lights for each of the colors, and controls the light amounts of all the light emitting elements of the light source unit with the selected data set as a reference.

19. The method according to claim 18, wherein the image forming apparatus further causes all the light emitting elements in the first light source unit to emit light and turns off all the light emitting elements in the second light source unit, causes the storing section to store first data, which is image pickup data of a state of the light emitting elements, causes all the light emitting elements in the second light source unit to emit light and turns off all the light emitting elements in the first light source unit, causes the storing section to store second data, which is image pickup data of a state of the light emitting elements, and controls a light amount of the light source unit having a larger value such that, of the first data and the second data stored in the storing section, the data having a larger value has a value of the other data.

20. The method according to claim 19, wherein the image forming apparatus further causes, after performing control based on the first data and the second data, the first light source unit and the second light source unit to simultaneously emit light for each of the colors, picks up an image for each of the colors, selects data having a smallest luminance value among picked-up three data of the simultaneously-emitted lights for each of the colors, and controls the light amounts of all the light emitting elements of the light source unit with the selected data set as a reference.
